(19) United States
(12) Patent Application Publication
(10) Pub. No.: US 2008/0136182 A1
(43) Pub. Date: Jun. 12, 2008

(54) Manifold flange

(75) Inventor: Markus Geminn, St. Martin (DE)

Correspondence Address: Muncy, Geissler, Olds & Lowe, PLLC, P.O. BOX 1364, FAIRFAX, VA, 22038-1364, US

(73) Assignee: Heinrich Gillet GmbH

(21) Appl. No.: 12/000,018

(22) Filed: Dec. 6, 2007

(30) Foreign Application Priority Data
Dec. 9, 2006 (DE) 202006018649

(51) Int. Cl. F16L 23/032

(52) U.S. Cl. 285/405; 123/193.5

(57) ABSTRACT

A manifold flange is provided for mounting on the cylinder head of internal combustion engines. The manifold flange includes a manifold housing, a pipe connecting flange, and, for each cylinder, an individual flange with a fastening means. To make handling easier, adjacent individual flanges are joined by an expansion arch.

This nonprovisional application claims priority under 35 U.S.C. §119(a) to German Patent Application No. DE 202006018649, which was filed in Germany on Dec. 9, 2006, and which is herein incorporated by reference.

### BACKGROUND OF THE INVENTION

1. Field of the Invention

The present invention relates to manifold flanges for mounting on a cylinder head of internal combustion engines, comprising a manifold housing, a pipe connecting flange, and, for each cylinder, an individual flange with fastening means.

2. Description of the Background Art

Manifold flanges for attaching to the cylinder head of internal combustion engines include a manifold housing, which directs hot exhaust gases emerging from the cylinders to a pipe connecting flange where additional exhaust gas treatment elements are fastened. The fastening of the manifold flange to the cylinder head takes place with the aid of flanges, which are installed with the aid of stud bolts and nuts, or with the aid of screws. A seal is located between the cylinder head and the flange.

The manifold housing is heated to temperatures up to approximately 900° C. by the hot exhaust gases, causing it to expand accordingly. In contrast, the cylinder attachment flanges reach maximum temperatures of approximately 120° C., since over large areas they are in contact with the cylinder head, which is water cooled. The extreme temperature differences result in corresponding differences in expansion which must be compensated. The manifold housing accommodates some of the difference in expansion. The other part of the difference in expansion is compensated by sliding of the cylinder head attachment flange on the seal.

It is a matter of course that the compensation of expansion is optimal when the cylinder head attachment flanges are designed as individual flanges. However, manufacture and installation of manifold flanges with individual flanges is very cumbersome. Each individual flange must be handled individually. Each individual flange must be placed in an installation fixture for installation on the manifold pipes, in which process it is necessary to ensure by suitable means that no interchanging occurs during placement of the three, four, five, etc. individual flanges, which would make the manifold flange defective. This is unsatisfactory.

### SUMMARY OF THE INVENTION

It is therefore an object of the present invention to provide manifold flanges for mounting on the cylinder head of internal combustion engines such that they can be handled and installed easily, quickly and reliably, without losing the desired properties for compensating differences in thermal expansion.

In an embodiment, this object is attained in that adjacent individual flanges are joined by expansion arches.

The present invention is based on the principle of connecting the individual flanges by expansion arches, which yield elastically to the motions of thermal expansion while still allowing handling comparable to a conventional sheet-metal flange. Measures for preventing interchange of the individual flanges are totally eliminated.

According to an embodiment of the invention, the arches are a single piece with the individual flanges. This permits production with a single stamping operation, which is to say in the shortest possible time.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates two sets of individual flanges, connected by expansion arches, that have been stamped from a sheet of metal;

FIG. 2 illustrates part of a set of individual flanges with alternative expansion arches; and

FIG. 3 illustrates a top view of the underside of a complete manifold flange.

### DETAILED DESCRIPTION

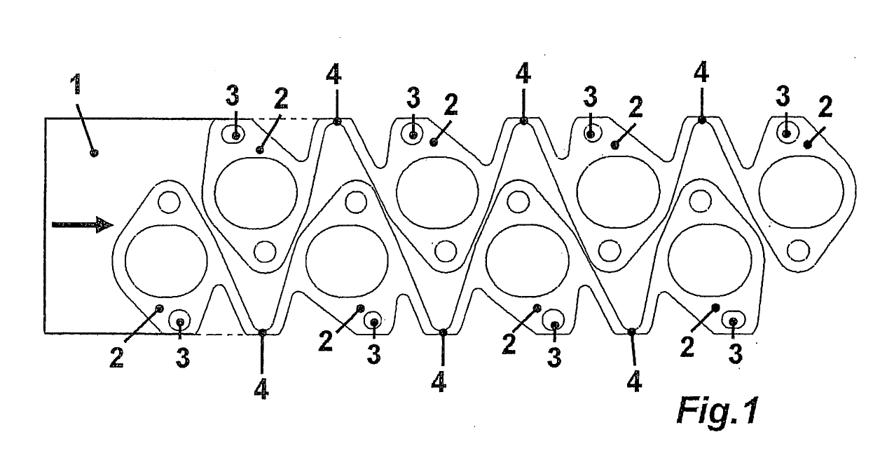

FIG. 1 shows a metal sheet 1, for example drawn from a coil, out of which are stamped two sets of individual flanges 2 with fastening openings 3. The individual flanges 2 are offset relative to one another for optimization of cuttings.

Adjacent individual flanges 2 of each set are joined together as one piece by an expansion arch 4. These expansion arches 4 are dimensioned such that they are stable enough to allow convenient and reliable handling of the complete set of individual flanges 2 and arches 4, but are also thin and elastic enough to permit movements of thermal expansion during operation of the internal combustion engine.

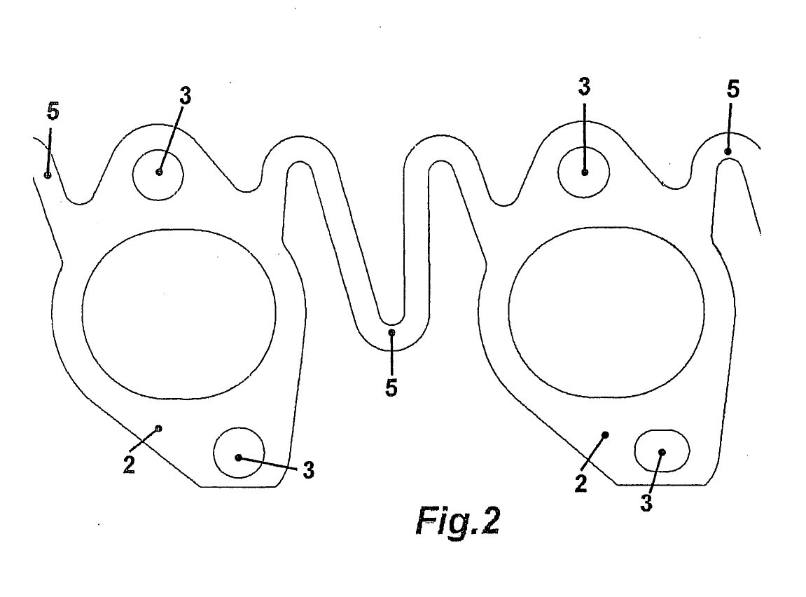

FIG. 2 shows an alternative embodiment. In this example, the expansion arches 5 are considerably longer in design in order to improve the elastic characteristics. In any event, however, this embodiment also ensures that the complete set of individual flanges 2 and expansion arches 5 can be handled without problem in the manufacturing plant until the flanges 2 are firmly attached to the manifold housing of the manifold flange.

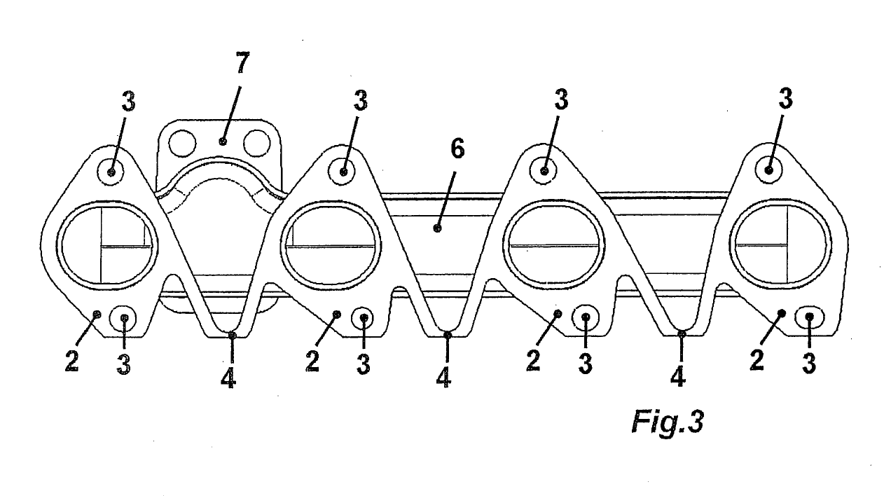

FIG. 3 shows a top view of the underside of a complete manifold flange. The individual flanges 2, which are joined by their expansion arches 4, are attached, for example welded, to a manifold housing 6. The manifold housing 6 collects the hot exhaust gases emerging from the cylinders of the internal combustion engine (not shown), and conducts them to a manifold connection with pipe flange 7, which is the mechanism for connecting to the other elements of an exhaust system (not shown).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A manifold flange configured to be mounted on a cylinder head of an internal combustion engine, the manifold flange comprising:
a manifold housing;
a pipe connecting flange;
an individual flange being provided for each cylinder, each individual flange having a fastener; and
an expansion arch joining adjacent individual flanges.

2. The manifold flange according to claim 1, wherein the expansion arches and the individual flanges are formed as a single piece.

3. The manifold flange according to claim 1, wherein the fastener is an opening.

4. The manifold flange according to claim 1, wherein the expansion arch permits movement caused by thermal expansion during operation of the internal combustion engine.
